(19) United States
(12) Patent Application Publication
(10) Pub. No.: US 2020/0273120 A1
(43) Pub. Date: Aug. 27, 2020

(54) POWER GRID DECISION-MAKING SUPPORT DEVICE AND METHOD, AND SYSTEM APPLYING SAME

(71) Applicant: Hitachi, Ltd., Tokyo (JP)

(72) Inventors: Kenta KIRIHARA, Tokyo (JP); Eisuke KURODA, Tokyo (JP); Nao SAITO, Tokyo (JP); Hiroo HORII, Tokyo (JP); Masahiro YATSU, Tokyo (JP)

(21) Appl. No.: 16/334,401

(22) PCT Filed: Feb. 24, 2017
(86) PCT No.: PCT/JP2017/007057

§ 371 Date: Mar. 19, 2019

(51) Int. Cl. G06Q 50/06; G06N 5/04; G06N 20/00; H02J 3/24

(52) U.S. Cl. CPC G06Q 50/06; H02J 3/24; G06N 20/00; G06N 5/04

(57) ABSTRACT

In order to provide a power grid decision-making support device and method which are capable of providing operator decision-making support, and quickly presenting control candidates, and a system which applies the same, one representative embodiment of the present invention provides a power grid decision-making support device characterized by comprising: a control candidate learning unit for deriving, by learning, a plurality of control candidate models for stabilizing a power grid; a control candidate extraction unit for extracting, from the plurality of control candidate models derived by the control candidate learning unit, control candidates using power grid measurement data and extraction parameters; a control candidate evaluation unit for evaluating the control candidates using a power grid model and the control candidates; and an information presentation unit for presenting information about the evaluation results and the control candidates.

### TECHNICAL FIELD

The present invention relates to a power grid decision-making support device and a method, and a system applying the same.

### BACKGROUND ART

In a power grid, it is difficult to secure the stabilization of the power grid due to the complication of the power grid by renewable energy and the like.

As a background art of the technical field relating to the present invention, PTL 1 is known. PTL 1 discloses, as an object of the invention, “a support function is easily realized at a low cost by providing a fault-time operation support device separately from a power grid monitor control system, without incorporating a support function inside this system”.

In addition, as a solution thereto, “The fault-time operation support device registers various fault patterns in a support database 10 in advance from the past faults and the like, and registers guidances for dealing with faults, which correspond to the registered fault patterns in a file database 12 in advance. When an information input device 8 obtains monitor information of a power grid monitor control system A, and an operation support device 9 detects the occurrence of a fault from the obtained monitor information, the support device 9 retrieves the registered fault patterns in the support database 10, based on the obtained monitor information, and extracts a corresponding fault pattern, retrieves and extracts a guidance for dealing with a fault which corresponds to the extracted fault pattern from the support database 10, and gives an appropriate guidance to an operator by CRTs 13 and 15, a speaker 14, and the like” is disclosed.

As a background art of the technical field of the invention, PTL 2 is known. PTL 2 discloses “a computer-based accidental event analysis method for fluctuation analysis, the method including, using one or more processors and various power grid devices connectable to the processors, generating sequences for performing fluctuation analysis, performing eigenvalue analysis, and calculating eigenvalues after fluctuation”.

### CITATION LIST

### Patent Literature

PTL 1: JP-A-2002-142362

PTL 2: US 2015/0105927

### SUMMARY OF INVENTION

### Technical Problem

In PTL 1, support for the registered fault patterns can be supported by storing various fault patterns in a support database from the past faults and the like. However, a fault that did not occur in the past cannot be supported. The support can be performed within one minute, but specific instructions cannot be given to an operator.

In PTL 2, there is provided a method of determining fluctuation stability using an accidental event analysis method. However, it is not possible to directly designate a control method, and it takes time to finish calculation in a huge grid.

In order to stabilize a complicated grid, it is necessary to present control candidates at a high speed.

In view of the above circumstances, an object of the present invention is to provide a power grid decision-making support device and a method capable of presenting control candidates at a high speed and providing an operator with decision-making support, and a system applying the same.

### Solution to Problem

In order to solve the above problems, one representative aspect of the present invention provides “a power grid decision-making support device including: a control candidate learning unit that derives a plurality of control candidate models for stabilizing a power grid by learning; a control candidate extraction unit that extracts control candidates from the plurality of control candidate models derived by the control candidate learning unit using power grid measurement data and extraction parameters; a control candidate evaluation unit that evaluates the control candidates using the control candidates and a power grid model; and an information presentation unit that presents information about the control candidates and the evaluation results”.

The present invention also provides “a power grid decision-making support method including: deriving a plurality of control candidate models for stabilizing a power grid by learning; extracting control candidates from the plurality of control candidate models using power grid measurement data and extraction parameters; evaluating the control candidates using the control candidates and a power grid model; and presenting information about the control candidates and the evaluation results”.

The present invention also provides “a power grid decision-making support method including: setting a state transitioning to a state after an event by an accidental event occurring in an initial state at the occurrence of the accidental event in a power grid, and then to a state after control by controlling the power grid as a control candidate model;

determining an electrical quantity of the power grid for the event of the control candidate model from a plurality of characteristic amounts obtained according to learning parameters and assuming a plurality of controls for control of the control candidate model; and

setting a plurality of control candidate models determined by the plurality of characteristic amounts and the plurality of controls and evaluating the plurality of control candidate models to extract control candidates”.

Further, the present invention proposes the following as an application device. An example of the application device is “a wide area monitoring protective control system using a power grid decision-making support device, the wide area monitoring protective control system including: a control command generation unit that creates a control command to be given to a control target device of the power grid by inputting the control candidates and the evaluation results from the decision-making support device; and a control target device that is controlled by the control command”.

As another example of the application device is “a grid operator training system using a power grid decision-making support device, the grid operator training system including: a decision-making support device that outputs the control candidates and the evaluation results by using virtual data as input; an accidental event calculation device that calculates an accidental event using a control command given from a grid operator according to the output of the decision-making support device; and an operator evaluation unit that evaluates the grid operator”.

As still another example of the application device is “a grid plan support system using a power grid decision-making support device, the grid plan support system including: a decision-making support device that outputs control candidate models; a parameter correction device that performs parameter correction using the control candidate models, target parameters, and a correction confirmation signal as input; and a display unit that displays a parameter correction result”.

### Advantageous Effects of Invention

According to the present invention, it is possible to present control candidates at a high speed and provide an operator with decision-making support using control candidate models learned from accidental event analysis results, accumulated measurement data, and control data.

The problems, configurations and effects other than those described above will be clarified by the description of embodiments.

### BRIEF DESCRIPTION OF DRAWINGS

FIG. 1 is a diagram illustrating an overall configuration example of a decision-making support device 1.

FIG. 2 is a diagram illustrating a hardware configuration of the decision-making support device 1 and a configuration example of a power grid 12.

FIG. 3 is a diagram illustrating an example of a process flow illustrating all processes of a decision-making support device.

FIG. 4 is a diagram illustrating a specific example of accidental event analysis result data D1 accumulated in an accidental event analysis result database DB1.

FIG. 5 is a diagram illustrating a specific example of past accumulated measurement data D2 accumulated in an accumulated measurement database DB2.

FIG. 6 is a diagram illustrating a specific example of past control data D3 (control history) accumulated in a control database DB3.

FIG. 7 is a detailed flow to perform a process of a control candidate learning unit 2.

FIG. 8 is a diagram illustrating the concept of a learning branch.

FIG. 9 is a diagram illustrating an example of a control candidate model.

FIG. 10 is a detailed flow to perform a control candidate extraction process.

FIG. 11 is a diagram illustrating a concept of control candidate extraction.

FIG. 12 is a diagram illustrating a concept of control candidate evaluation.

FIG. 13 is a diagram illustrating an information presentation process in a process step S7.

FIG. 14 is a diagram illustrating an example of an information presentation unit.

FIG. 15 is a diagram illustrating an example of an image display unit.

FIG. 16 is a diagram illustrating an example of information presentation in a state where an image or a printed matter cannot be confirmed.

FIG. 17 is a diagram illustrating a configuration example when the decision-making support device 1 according to Example 1 is applied to a wide area monitoring protective control system.

FIG. 18 illustrates a process flow example of the wide area monitoring protective control system.

FIG. 19 is a diagram illustrating a configuration example of a grid operator training system.

FIG. 20 illustrates a process flow example of the grid operator training system.

FIG. 21 is a diagram illustrating an application example of the grid operator training system.

FIG. 22 is a diagram illustrating a configuration example of a grid plan support system.

FIG. 23 illustrates a process flow example of the grid plan support system.

FIG. 24 is a diagram illustrating an application example of the grid plan support system.

### DESCRIPTION OF EMBODIMENTS

Hereinafter, examples of the present invention will be described with reference to the drawings.

### Example 1

Example 1 is an example in which a decision-making support system is applied to a power grid stabilization operation.

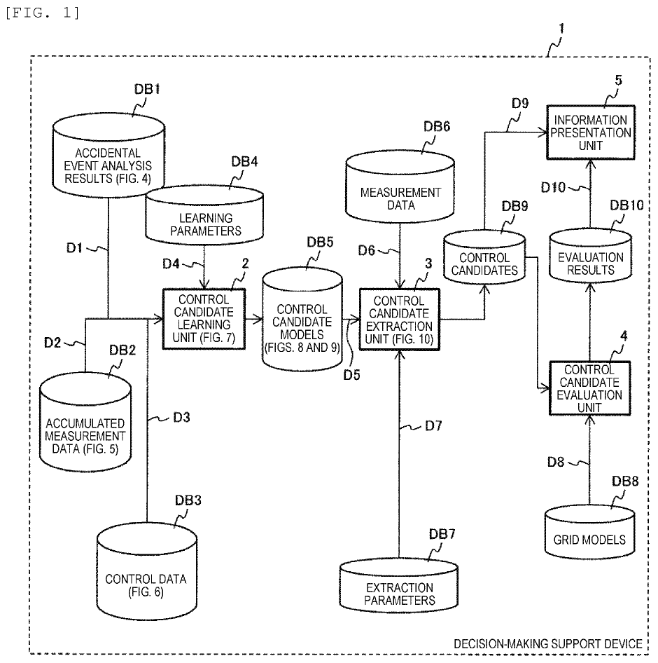

FIG. 1 is a diagram illustrating an overall configuration example of a decision-making support device 1 according to Example 1. The decision-making support device 1 is configured of a computer system, but in FIG. 1, databases DB possessed by the decision-making support device 1 and the internal processing functions are illustrated in the form of blocks.

The databases DB possessed internally are an accidental event analysis result database DB1, an accumulated measurement data database DB2, a control data database DB3, a learning parameter database DB4, a control candidate model database DB5, a measurement data database DB6, an extraction parameter database DB7, a grid model database DB8, a control candidate database DB9, and an evaluation result database DB10.

Among the processing functions, a control candidate learning unit 2 forms the control candidate model database DB5 by using each data accumulated in the accidental event analysis result database DB1, the accumulated measurement data database DB2, the control data database DB3, and the learning parameter database DB4 as input.

A control candidate extraction unit 3 forms the control candidate database DB9 by using each data accumulated in the control candidate model database DB5, the measurement data database DB6, and the extraction parameter database DB7 as input.

A control candidate evaluation unit 4 forms the evaluation result database DB10 by using each data accumulated in the control candidate database DB9 and the grid model database DB8.

An information presentation unit 5 present support information by using each data accumulated in the control candidate database DB9 and the evaluation result database DB10 as input.

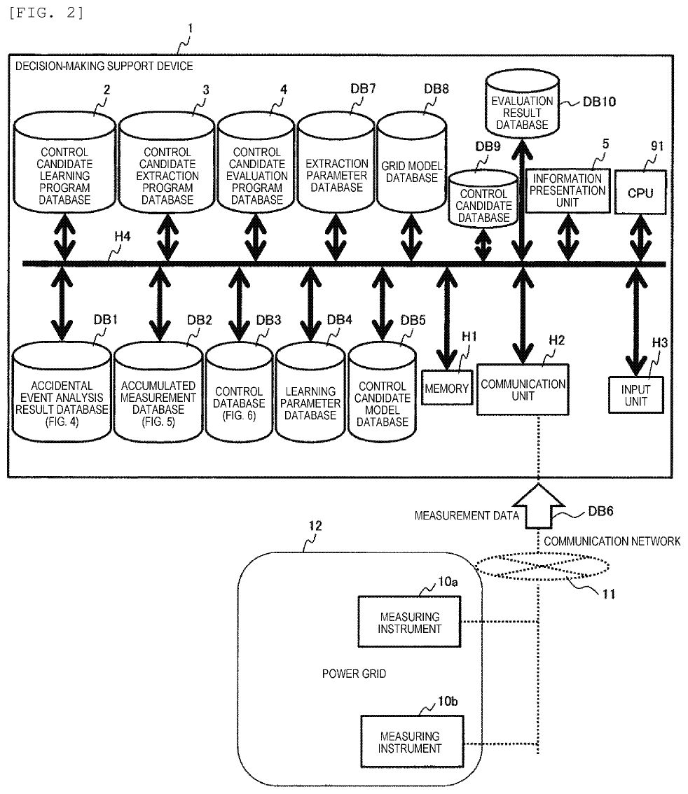

FIG. 2 is a diagram illustrating a hardware configuration of the decision-making support device 1 according to the Example and a configuration example of a power grid 12.

In FIG. 1, the decision-making support device 1 is described from the viewpoint of databases DB and processing functions, but in FIG. 2, the decision-making support device is described from the viewpoint of a hardware configuration. In a case of describing the decision-making support device from the viewpoint of a hardware configuration, the decision-making support device 1 is configured such that a plurality of databases DB (DB1 to DB10), a memory H1, a communication unit H2, an input unit H3, a CPU 91, an information presentation unit 5, and a plurality of program databases 2, 3, and 4 are connected to a bus H4.

In the hardware configuration in FIG. 2, first, for example, the input unit H3 can be configured to include at least one of a keyboard switch, a pointing device such as a mouse, a touch panel, a tablet, a voice instruction device, and the like. The input unit H3 may be a user interface other than the above.

The communication unit H2 includes a circuit and a communication protocol for connecting to the communication network 11.

The memory H1 is configured as, for example, a random access memory (RAM), and stores a computer program read from each of the program databases 2, 3, and 4 or stores calculation result data and image data required for each process. The memory H1 is a memory that temporarily stores the measurement data database DB6, image data for display, and temporary calculation data such as calculation result data, calculation results, and the like, and the required image data is generated by the CPU 91 to be displayed on the information presentation unit 5 (for example, display screen). In the calculation process, the physical memory of the memory H1 is used, but a virtual memory may be used.

The image data stored in the memory H1 is transmitted to and displayed on the information presentation unit 5. The information presentation unit 5 is configured as one or more of, for example, a display, a printer device, an audio output device, a portable terminal, and a wearable device. An example of a screen to be displayed will be described later.

The CPU 91 reads a predetermined computer program from each of the program databases 2, 3, and 4 and executes the program. The CPU 91 may be configured as one or a plurality of semiconductor chips, or may be configured as a computer device such as a calculation server. The CPU 91 executes each calculation program read into the memory H1 from each of the program databases 2, 3, and 4, and performs a calculation process such as retrieval of data in various databases (DB 1 to DB 10).

The power grid 12 exemplified in FIG. 2 includes a measuring instrument 10a and a measuring instrument 10b (hereinafter, referred to as a measuring instrument 10), and the measuring instrument 10 measures measurement values at each place in the power grid and transmits the measurement results to the communication unit H2 of the decision-making support device 1 via the communication network 11. The measurement values received by the decision-making support device 01 by the transmission are temporarily held in the memory H1 and then stored as the measurement data D6 in the measurement data database DB6.

Here, examples of the measuring instrument 10 include measuring instruments and measuring devices to be installed in the power grid, such as phasor measurement units (PMU), a voltage transformer (VT), a potential transformer (PT), a current transformer (CT), and a Telemeter (TM). The measuring instrument 10 may be an aggregating device for measured values installed in a power grid such as supervisory control and data acquisition (SCADA).

The data on the power grid measured by the measuring instrument 10 is stored and held in the measurement data database DB6 in the decision-making support device 1 at the beginning of the measurement, and then is held in the accumulated measurement data database DB2. The specific data on the power grid is power information with synchronization time using GPS or the like, and for example, is information on one or more of voltage and current. The measurement data database DB6 may include a unique number for identifying data and a time stamp or may include a measurement value complemented by state estimation using SCADA.

The measurement data D6 stored in the measurement data database DB6 is as described above, but the outline of the stored contents of the databases other than the measurement data database DB6 is as follows.

First, in the accidental event analysis result database DB1, controls and the like for accidental events in various assumed initial states are accumulated and stored as accidental event analysis result data D1.

FIG. 4 exemplifies a specific example of the accidental event analysis result data D1 accumulated in the accidental event analysis result database DB1. The accidental event analysis result data D1 is time-series information with control on various events which are assumed from a certain time and an initial state. Here, the initial state is accumulated as a characteristic including one or more of measurement data or virtual data and analysis results thereof.

Specifically, as exemplified in FIG. 4, for each accidental event case, occurrence time D11, an initial state characteristic D12, an accidental event type D13, a characteristic after accidental event D14, a control content performed on the accidental event D15, a characteristic after control D16, and an evaluation result in the case D17 are stored.

For example, in the case of Case 1, it is stored that the occurrence time D11 is “2016/12/25, 10:52”, the initial state characteristic D12 is “each power generator output P and Q and frequency F”, the accidental event type D13 is “transmission line fault 1”, the characteristic after accidental event D14 is “similar frequency, voltage drop”, the control content performed on the accidental event D15 is “output reduction of power generator 1”, the characteristic after control D16 is “similar attenuation rate 70%”, the evaluation result in the case D17 is “10”, and the like. For the evaluation result D17, a high numerical value is given when the control result (control effect) for the event is great. Meanwhile, in the examples in cases 2 and 3, the numerical values as the evaluation results are low, and it can be understood that those cases are events in which a great control effect is not obtained.

The accidental event analysis result database DB1 is a database in which assuming that an assumed failure (D13) of an assumed scale occurs at the assumed places of the power grid in the initial state (D12) in which the required power grid is in a stable state, and at this time, the fluctuation degree (D14) of the power grid and the fluctuation convergence degree (D16) when a stabilization control (D15) such as power control or load control is executed to converge the fluctuation are obtained, based on the prior flow current calculation result or based on the past experience analysis result, in time series (D11) during the period from occurrence of failure to convergence (or divergence) of fluctuation and the evaluation result for stabilization is added. Thus, it is possible to grasp the characteristics after assumable events and control effects at various times and initial conditions.

FIG. 5 exemplifies a specific example of past accumulated measurement data D2 accumulated in the accumulated measurement database DB2. In the example, the accumulated measurement data DB2 illustrates overall measurement values in the power grid. This data is data measured by measurement values of PMU, SCADA, and the like. As illustrated in FIG. 5, a plurality of pieces of information may be accumulated in each time section, or the data may be data representing the state of the opening and closing path of the instrument.

In FIG. 5, an occurrence time D21, a measurement value D22, and a measurement information D23 are stored as time series information. For example, in the case example of FIG. 5, when the occurrence time D21 is “2016/12/25, 10:52”, information such as “SCADA, bus No. 13, voltage”, “PMU measurement bus No. 123, phase”, or the like is stored as the measurement information D23 and the measurement values D22 such as “100” and “10” are stored in time series. According to the accumulated measurement database DB2, various electrical quantities at various places of the power grid at a certain time are grasped in a cross-sectional and time-series manner. This means that it is possible to grasp the correlation between various electric quantities and the relationship of the time-series variation.

FIG. 6 exemplifies a specific example of past control data D3 (control history) accumulated in the control database DB3. In the control data D3, the control at a certain time section is accumulated. This control is a control for changing the state of the power grid such as reduction of output of the power generator, and opening and closing path of the transmission line. The control may be carried out by a grid operator or the like or may be carried out automatically by a protection device or the like.

Here, the occurrence time D31 and the control D32 are stored for each case. For example, in the case of Case 1, it is stored that at the occurrence time D31 of “2016/12/25, 10:52”, the control D22 “output reduction of power generator 1” is executed. That is, for Case 1, the fact that the output reduction of the power generator 1 has been performed at a certain time is stored as data.

Although not specifically illustrated, the other databases are as follows. The specific contents thereof will be described as appropriate. In the learning parameter database DB4, learning parameter data D4 for learning the control candidate is accumulated; in the control candidate model database DB5, control candidate model data D5 is accumulated based on the event type; in the extraction parameter database DB7, the parameter data D6 for extracting control candidates is included; and in the grid model database DB8, a model data D8 for analysis of the power grid is accumulated.

Next, regarding the calculation process contents of the decision-making support device 1 according to Example 1 will be described using FIG. 3. FIG. 3 is a diagram illustrating an example of a process flow illustrating all processes of the decision-making support device 1. The contents will be described along the process steps S1 to S7.

First, in a process step S1, each of the stored data D1, D2, D3, and D4 is read out from the accidental event analysis result DB1, the accumulated measurement data DB2, the control database DB3, and the learning parameter database DB4. Here, each data may be aggregated and stored as a plurality of tables of one or more databases.

In the accidental event analysis result data D1 of the accidental event analysis results DB1 illustrated in FIG. 4 to be read out in this case, various events are assumed from a certain time and initial state, and controls are provided for the events. Here, the initial state is accumulated as a characteristic including one or more of measurement data or virtual data, and the analysis results thereof. As illustrated in FIG. 4, the accidental event analysis result data D1 is constituted of time D11, the initial state characteristic D12, the accidental event type D13, the characteristic after accidental event D14, the control D15, the characteristic after control D16, and the evaluation D17. Thus, it is possible to grasp the characteristics after assumable events and control effects at various times and initial conditions.

The accumulated measurement data D2 of the accumulated measurement data database DB2 illustrated in FIG. 5 to be read out in this case illustrates overall measurement values in the power grid. This data is data measured by measurement values of PMU, SCADA, and the like. As illustrated in FIG. 5, a plurality of pieces of information may be accumulated in each time section, or the data may be data representing the state of the opening and closing path of the instrument.

In the control data D3 of the control data database DB3 illustrated in FIG. 6 to be read out in this case, the control at a certain time section is accumulated. This control is a control for changing the state of the power grid such as reduction of output of the power generator, and opening and closing path of the transmission line. The control may be carried out by a grid operator or the like or may be carried out automatically by a protection device or the like.

In the next process step S2 of the process flow illustrated in FIG. 3, the control candidate learning unit 2 in FIG. 1 executes the process but the specific content thereof is illustrated in the detailed flow in FIG. 1.

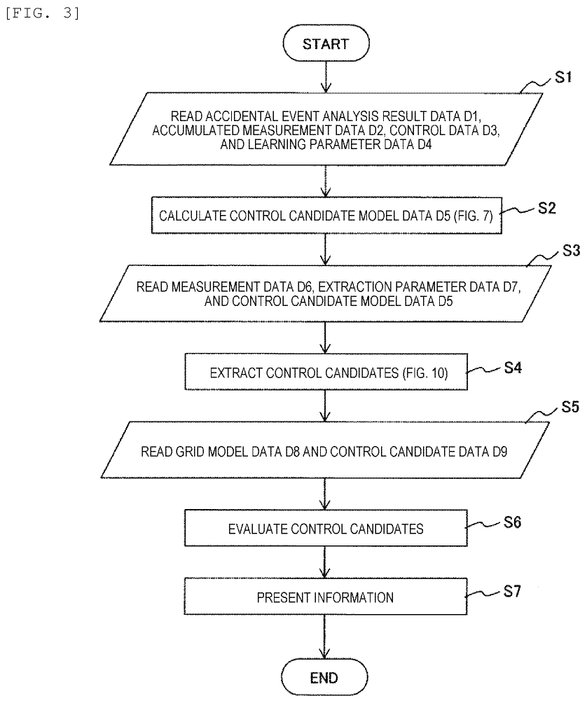

In the detailed flow of the process step S2 in FIG. 7, first, in a process step S201, the characteristic amount is extracted from the accumulated measurement data D2 based on the learning parameter data D4. Specifically, for example, the time-series data of a plurality of electric quantities stored in the accumulated measurement data D2 is subjected to a clustering process and is classified, and the characteristic amount is extracted for each of the classified group. The learning parameter data D4 is used at clustering. The classified characteristic amounts include the characteristic amount of the power grid when an event cause for stabilizing the power grid is.

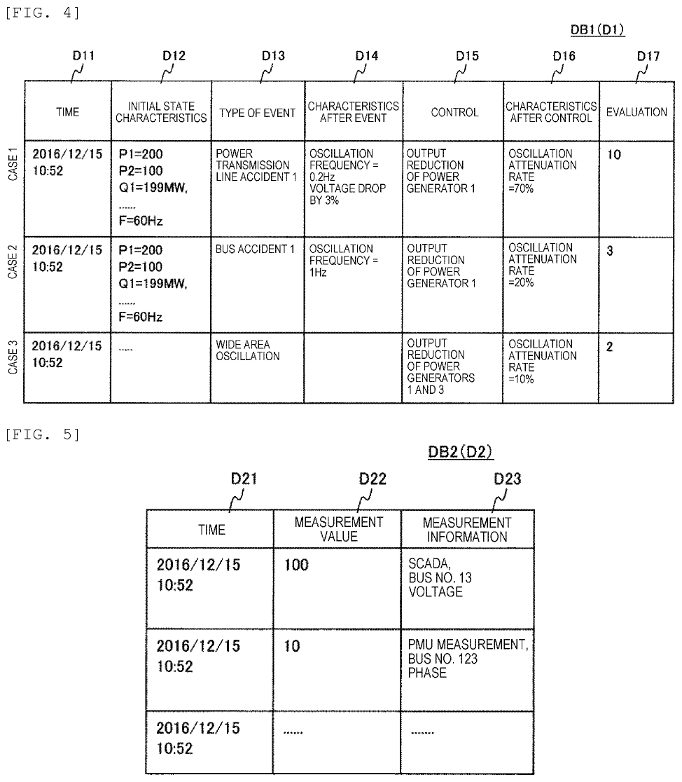

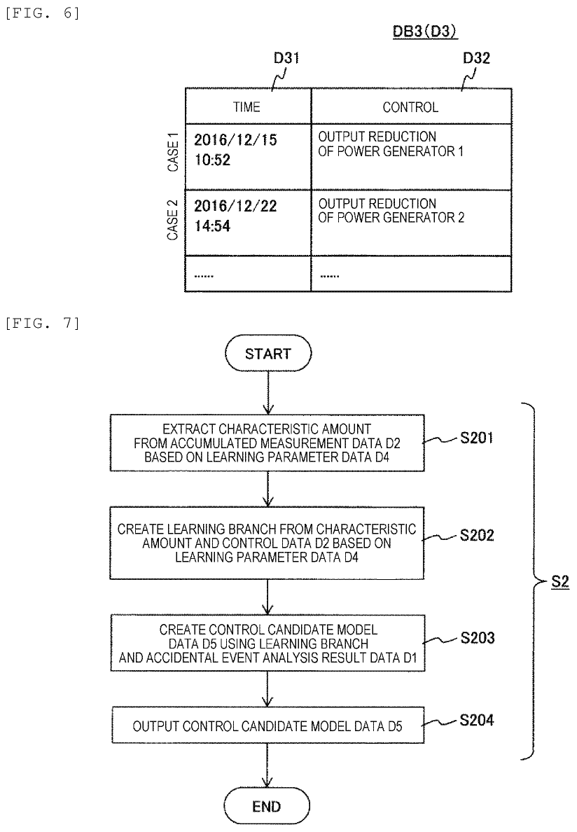

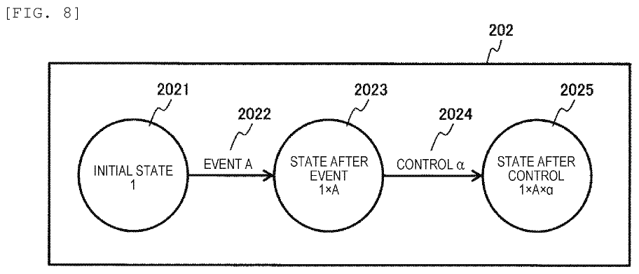

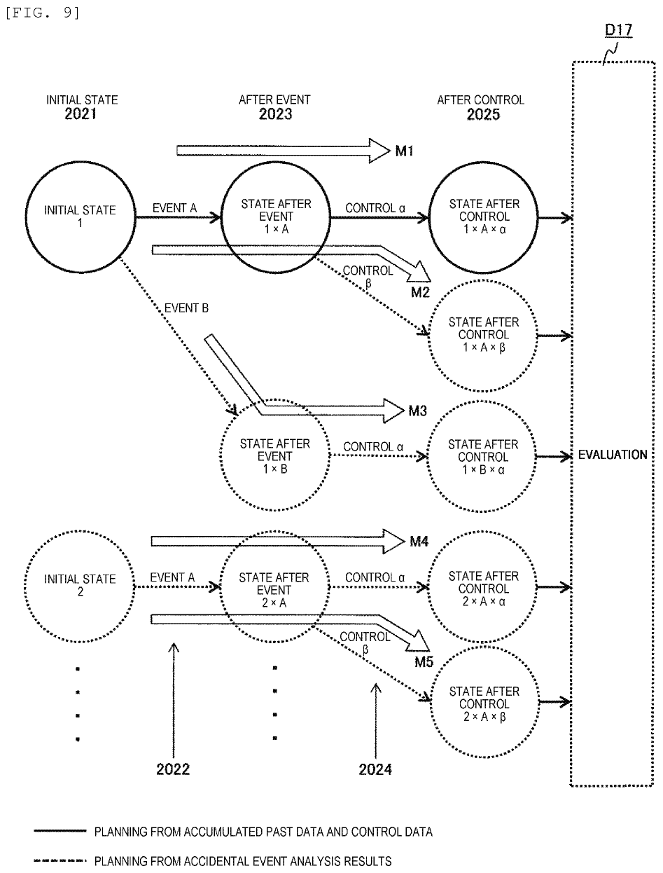

In a process step S202, a learning branch is created from the extracted characteristic amount and the control data D3. FIG. 8 is a diagram illustrating the concept of a learning branch. Here, using FIG. 8, the relationship between a learning branch 202 and the learning parameter data D4 will be described. In FIG. 8, the learning branch 202 is constituted of three or more states of an initial state 2021 calculated from the accumulated measurement data D2, a state after the event 2023 and a control state 2025, and the transition between each state (event 2022 and control 2025) is created from the analysis result of the accumulated measurement data DB2 and the control data DB3.

The concept of the learning branch focuses on the relationship in FIG. 4. In particular, when attention is paid to the horizontal axis item in FIG. 4, this means that an event occurs in the initial state and as a result, the state is transitioned to the state after the event. As a result of performing the control for stabilization, the transition to the state after control is made.

On the occurrence of an abnormal event and the subsequent state in the power grid, the learning branch in FIG. 8 is divided into the states before and after the transition and the cause at the transition, and the causal relationship is clarified. The states before and after the transition are the initial state 2021, the state after the event 2023, and the state after control 2025. The transition is caused by the event occurrence 2022, and the control execution 2024. Through the event occurrence 2022 (which is set to A), the state transition is performed from the initial state 2021 (which is set to 1) to the state after the event 2023 (can be referred to as 1×A). Through the control execution 2024 (which is set to α), the state transition is performed from the state after the event 2023 (1×A) to the state after control 2025 (1×A×α).

In the learning branch 202, the event occurrence 2022 and the control execution 2024 as causes at the transition, the event occurrence 2022 is grasped by the characteristic amount which is obtained in advance. In addition, the control execution 2024 refers to the control data D3.

In the present invention, in particular, when calculating a characteristic amount, which means the event occurrence 2022, the learning parameter data D4 is referred to. The learning parameter data D4 is used at clustering, but indicates a plurality of directions and a plurality of concepts in normal cases, for example, guidelines for grasping the occurrence of a power fluctuation event from the relationship between the voltage and the phase of a specific bus, guidelines for grasping the occurrence of power fluctuation events from the relationship of voltages at different multiple buses, and guidelines for grasping the occurrence of power fluctuation events from the relationship between active power and reactive power. The learning parameter data D4 is to change the combination of electric quantities or to propose a new combination.

Similarly, regarding the control execution 2024, proposed is an example of executing power control and load control by instrument operation in other places other than instrument operation at places described in the control data D3, when the control data D3 is referred to.

In the learning branch 202, as a result of the fact that the event occurrence 2022 and the control execution 2024 as causes at the transition are proposed variously, when the initial state 2021 is the same, the state after the event 2023 and the state after control 2025 of different results are derived as a plurality of combinations.

These states are represented by the characteristic amounts designated by the learning parameter data D4. The learning branch 202 is obtained by learning a phenomenon occurred in the power grid, the measures against the phenomenon, and the result thereof. The characteristic amounts may be the measurement values of the measurement data as they are and may be obtained by analyzing the measurement values. In addition, the learning parameter data D4 may include a similarity determination parameter for determining a plurality of similar states as one state.

In a process step S203 in FIG. 7, using the learning branch 202 and the accidental event analysis result data D1, a control candidate model data D5 is created. Next, the specific concept of the process step S203 will be described using FIG. 9.

When creating the control candidate model DB5, first, the learning branch 202 is used as the basis. The control candidate model DB5 is created by applying, expanding and evaluating the cumulative accidental event result database D1 in the learning branch 202.

In the learning branch 202 obtained in the process step S202, the event occurrence 2022 and the control execution 2024 as causes at the transition are proposed variously. Accordingly, the initial state (initial state or state after the event, or both) can be considered and assumed. If the initial state is confirmed, the subsequent state can be expanded variously according to the proposal of the learning branch 202.

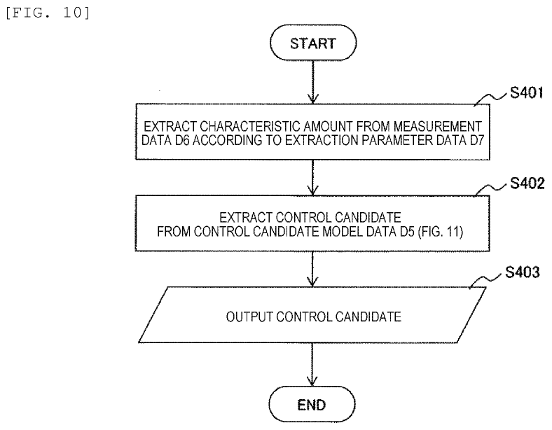

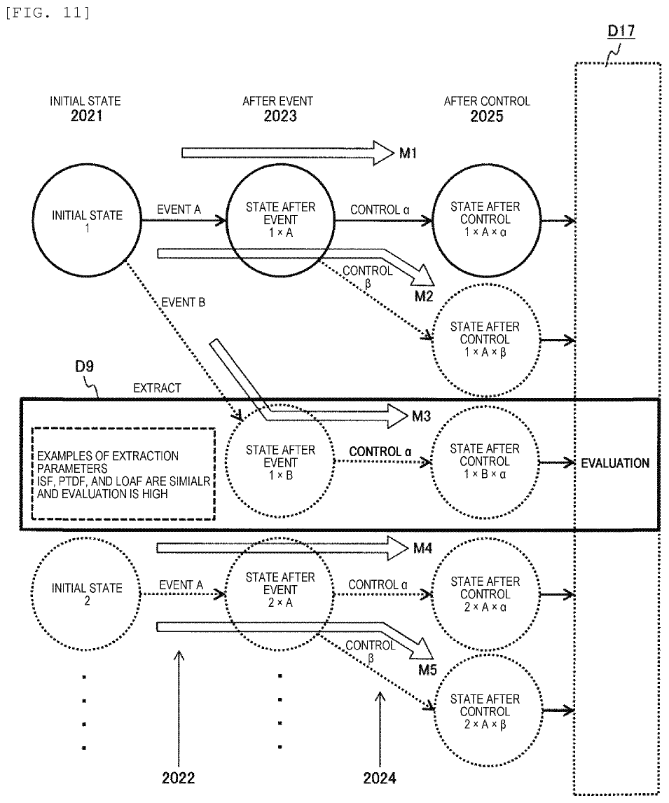

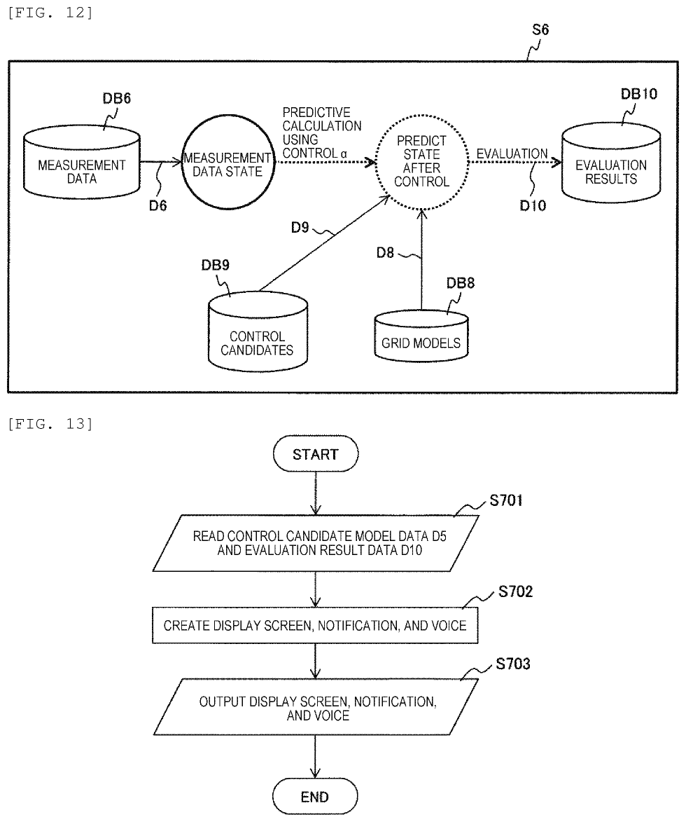

FIG. 9 illustrates an example of a control candidate model, and for example, in the upper part of FIG. 9, a first model M1 indicated by a thick solid line is, for example, a model representing a series of events set from the accumulated measurement data D2 and the control data D3. In contrast, a modified model in which a control p proposed by the learning branch 202 is reflected is a model M2. A modified model in which an event B proposed by the learning branch 202 only using the initial state 1 of the model M1 is reflected is a model M3. A model M4 is a model that is determined the initial state as a completely new state, and a model M5 is a modified model of the control 2024. Regarding these models, the control effect is appropriately evaluated by the method of FIG. 11 to be described later. In FIG. 9, the dotted line indicates a flow formulated using the accidental event diffraction result data D1.

Through these modified model creation methods, a plurality of control candidate model data D5 is created and accumulated by the process step S203 as a result.

In this manner, as illustrated in FIG. 9, learning may be performed using the accumulated accidental event analysis result DB1 such as a different event from the initial state of the learning branch 202 or a different control method, or the data may be created based on an initial state not existing in the learning branch 202. Thus, the control candidate models DB5 are obtained by integrating the past events and an assumed event from the learning branch.

In FIG. 7, in the final process step S204, the control candidate model data D5 is output.

Returning to FIG. 3, in a process step S3, the measurement data D6, the extraction parameter data D7, and the control candidate model data D5 are read. In a process step S4, control candidates are extracted. Here, the details of the process step S4 will be described using FIG. 10.

In FIG. 10, in a process step S401, the characteristic amount is extracted from the measurement data D6 according to the extraction parameter data D7. Clustering or the like can be used as a characteristic amount extraction method. In a process step S402, the control candidate data D9 is extracted from the control candidate model data D5. In a process step S403, the control candidate data D9 is output. Here, the extraction parameter data D7 includes the characteristic amounts extracted from the measurement data D6, conditions extracted from the control candidate model data D5, and the like. By setting the extraction parameter data D7, a grid operator can extract the optimal control candidate based on various findings.

Next, FIG. 11 illustrates an example of control candidate extraction. FIG. 11 basically shows the same as the flow of FIG. 9. Here, as the evaluation result, it is indicated that the model M3 is selected as the best. In this manner, the control candidate model data D5 is referred to, based on the characteristic amounts extracted from the measurement data D6, and the control candidate data D9 with the highest evaluation and the state in which the characteristic amounts match most is extracted. Here, there may be one or more control candidate data D9 to be extracted. As an example of the extraction parameter, it is desirable that the region sensitivity ISF, the inter-area sensitivity PTDF and the transmission line importance KOAF are similar and the evaluation is high.

Returning to FIG. 3, in a process step S5, the grid model data D8 and the control candidate data D9 are read. In a process step S6, the control candidate data D9 is evaluated.

An example of the process step S6 will be described using FIG. 12. Here, the state of the measurement data D6 is grasped from the characteristic amounts of the measurement data D6, and the state after the control is predicted by performing prediction calculation based on the grid model data D5 and the control candidate data D9. The state after this control is evaluated and the evaluation result is output as the evaluation result DB10.

Returning to FIG. 3, information is presented in a process step S7, and the process flow ends. FIG. 13 illustrates an information presentation process in the process step S7, and in a process step S701, the control candidate data D5 and the evaluation result data D10 are read, and in a process step S702, a display screen, notification, and voice are created, and in a process step S703, a display screen, notification, and voice are output.

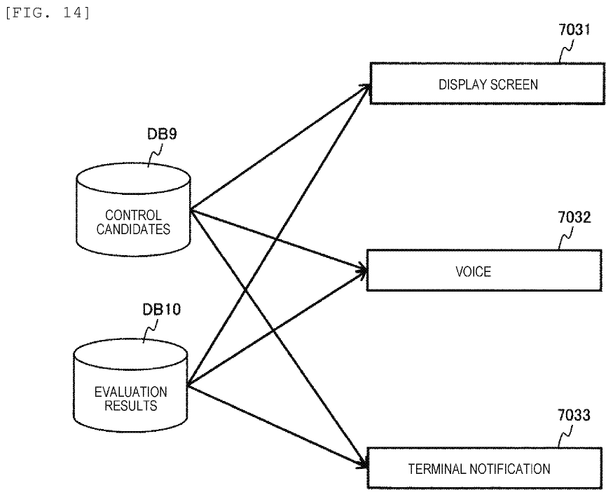

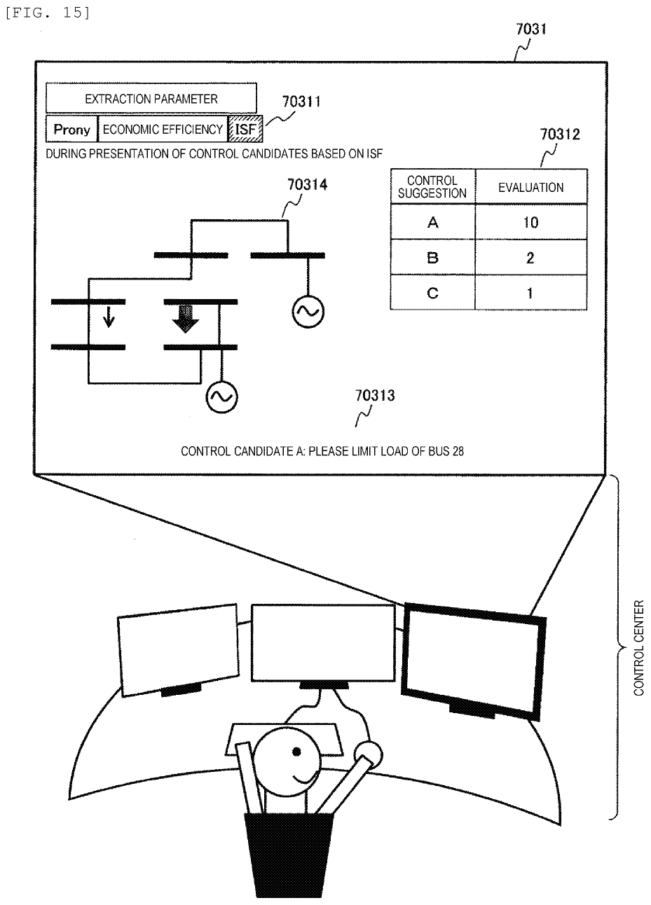

Here, an example of the information presentation unit will be described using FIG. 14. The information presentation unit 5 includes one or more of a screen display unit 7031, a voice output unit 7032, and a terminal notification unit 7033. The screen display unit 7031 may be a means for converting electronic data into a light source, such as a monitor or a screen, or may be a matter created by a printer or a three-dimensional model. The voice output unit 7032 may be an artificially created sound source such as a voice guidance or may be learning of a recorded sound source. The terminal notification unit 7033 will be described later.

FIG. 15 shows an example of the screen display unit 7031 in Example 1. A decision-making support device 01 including the screen display unit 7031 installed in a control center displays one or more of selective extraction parameter data 70311, control candidate list data 70312, control candidate detailed data 70313, and grid state data 70314. In the control candidate list data 70312, the evaluation result data D10 is displayed. By referring to this, the grid operator can perform proper grid control.

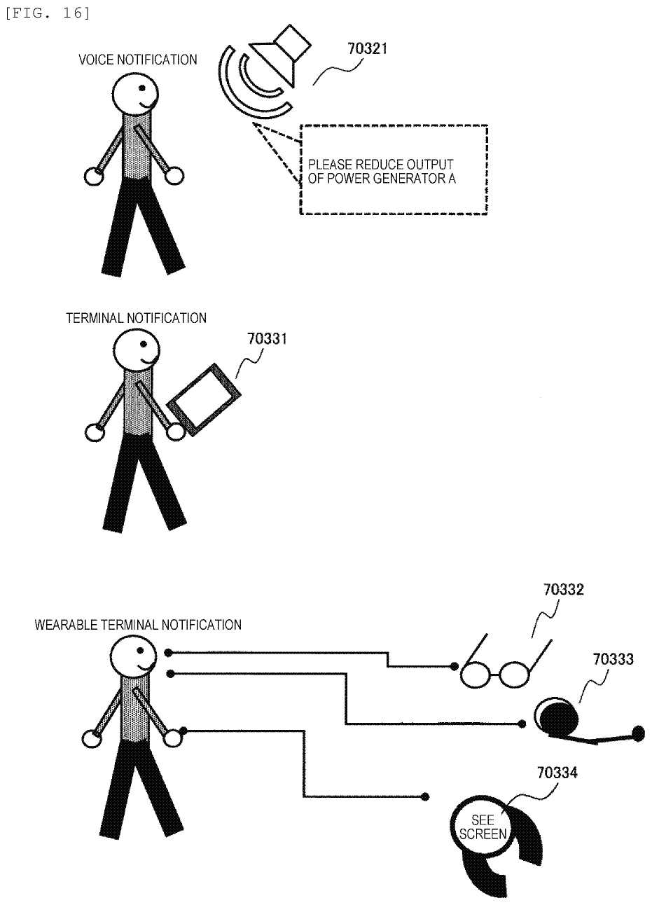

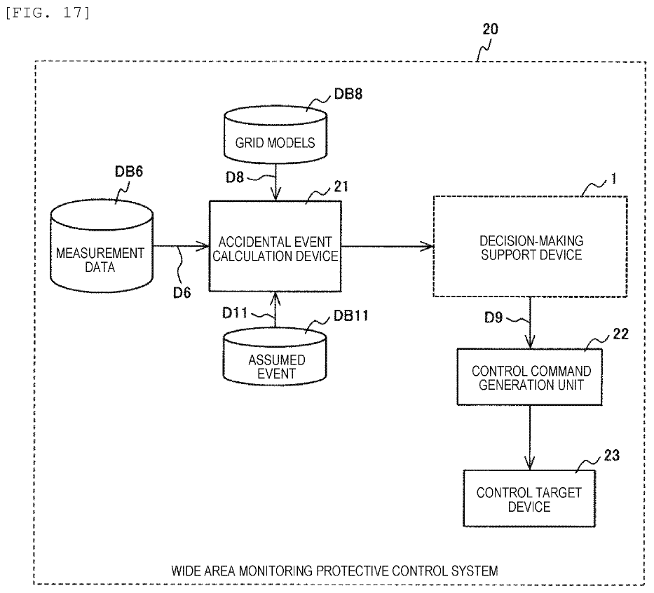

FIG. 16 illustrates an example of the voice output unit 7032 and the terminal notification unit 7033 in Example 1. In Example 1, a case where the grid operator cannot refer to the screen display unit 7031 for the reason such as being away from the seat or the like is a target. For example, when notifying one or more of the control candidate data D5 and the evaluation result data D10, a voice control notification 70321 may be given, a mobile terminal notification 70331 may be given, glasses with a communication function 70332 may be used, an audio device with a communication function 70333 may be used, and a time grasping device with a communication function 70334 may be used. Thus, the grid operator can grasp one or more of the control candidate data D5 and the evaluation result data D10 even when the screen display unit 7031 cannot be used, and thus can control the grid.

### Example 2

Example 2 is a configuration example when the decision-making support device 1 of Example 1 is applied to a wide area monitoring protective control system.

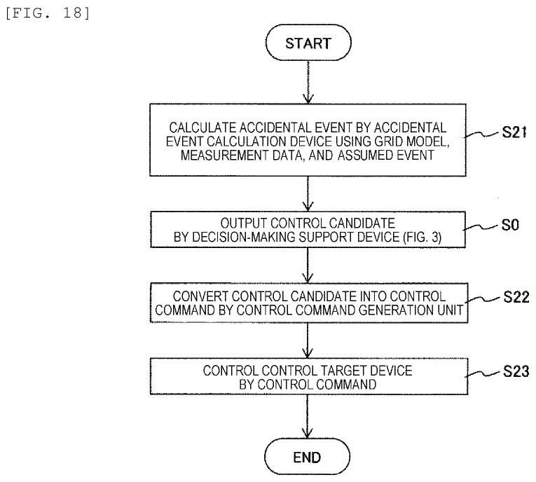

FIG. 17 is a diagram illustrating a configuration example of a wide area monitoring protective control system 20. The wide area monitoring protective control system 20 includes an accidental event calculation device 21 that inputs each data D6, D8, and D11 from the grid model database DB8, the measurement database DB6, and an assumed event database DB11 and outputs an accidental event calculation result; the decision-making support device 1 that outputs the control candidate data D9 by inputting the results; a control command generation unit 22 that outputs a control command by inputting the control candidate data D5; and a control target device 23 that is controlled by the control command. Other parts are the same as those of the decision-making support device 1 in FIG. 1 and thus the description thereof is omitted.

Here, the processing flow of the Example will be described using FIG. 18. In a process step S21, accidental event calculation is performed by the accidental event calculation device 21 using the grid model data D8, the measurement data D6, and the assumed event D11. In a process step S0, the control candidate data D9 is output by the decision-making support device 1. In a process step S22, the control candidate data D9 is converted into a control command by the control command generation unit 22. In a process step S23, the control target device 23 is controlled by the control command.

According to the embodiment, first, the accidental event analysis result data D1 can be updated using the accidental event calculation device 21, and the accuracy of the control candidate model data D5 can be increased. In addition, by using the output of the decision-making support device 1 as a control command, high-speed automatic control can also be performed in the wide area monitoring protective control system 20.

### Example 3

Example 3 is a configuration example when the decision-making support device 1 of Example 1 is applied to a grid operator training system.

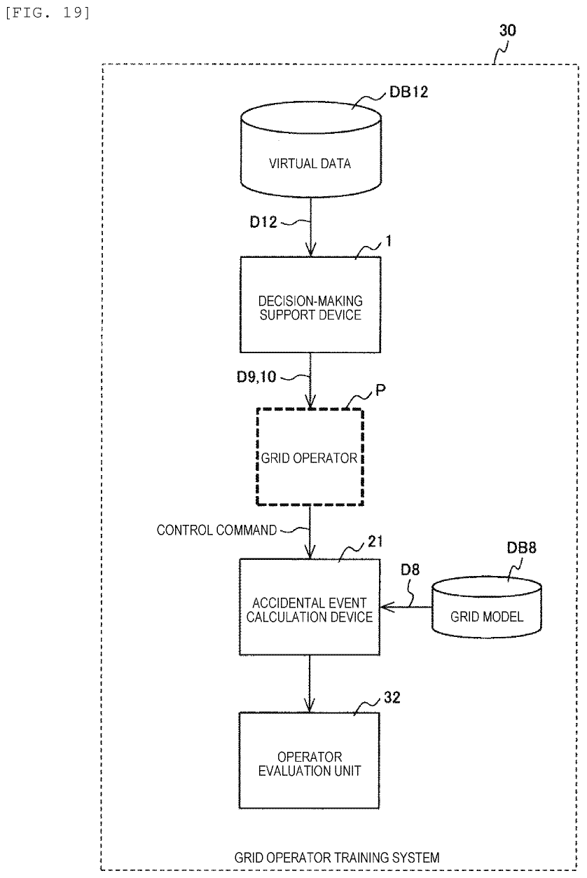

FIG. 19 is a diagram illustrating a configuration example of a grid operator training system 30. The grid operator training system 30 includes the decision-making support device 1 that inputs a virtual data D12 recorded in a virtual data database DB12 and outputs the control candidate data D9 and the evaluation result data D10; the accidental event calculation device 21 that performs accidental event calculation using the grid model data D8 as input; and an operator evaluation unit 32 that performs evaluation of an operator using the simulation result as input. In this system, a grid operator P is interposed and the grid operator P grasps the control candidate data D9 and the evaluation result data D10 sent from the decision-making support device 1 and sends a control command to the accidental event calculation device 21.

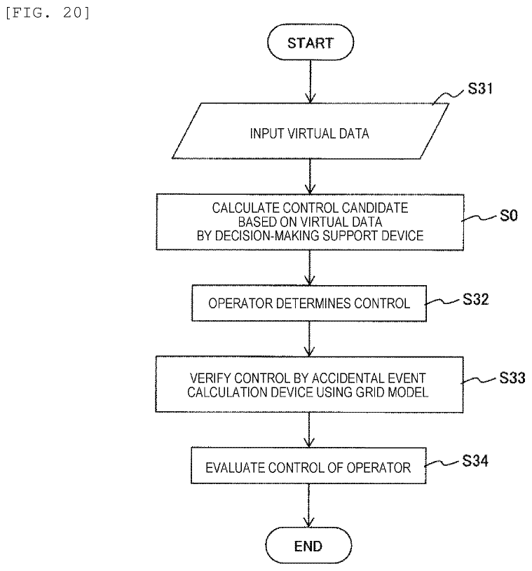

A processing flow of the grid operator training system 30 will be described using FIG. 20. In a process step S31, the virtual data D12 is input. Here, the virtual data D12 is data designated by an operator or a trainee P. The virtual data D12 may be an example based on past cases or may be data based on imaginary scenarios. In a process step S0, the control candidate is calculated based on the virtual data D12 in the decision-making support device 1. In a process step S32, the operator P determines control. In a process step S33, the grid model data D8 is input, and the control is verified in the accidental event calculation device 21. In a process step S34, the control of the operator is evaluated.

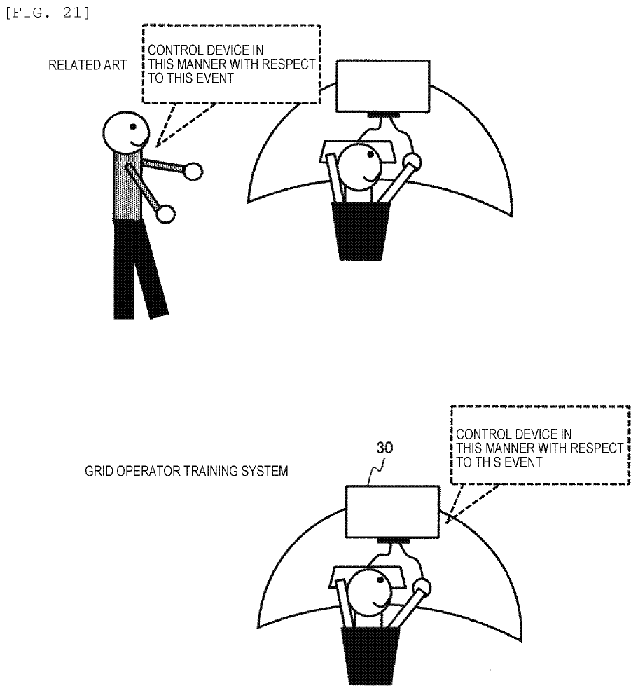

The effect of the third embodiment will be described in FIG. 21. In the grid operator training of the related art, instructors other than the grid operator need to provide guidance. In a case of using the grid operator training system 30, the device automatically evaluates and train the grid operator P without requiring instructors other than the grid operator P are not necessary. Thus, operation efficiency is improved.

### Example 4

Example 4 is a configuration example when the decision-making support device 1 of the first embodiment is applied to a grid plan support system.

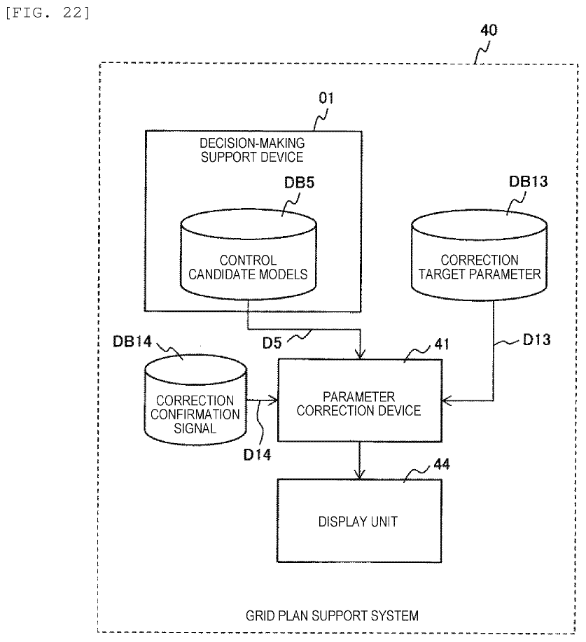

FIG. 22 is a diagram illustrating a configuration example of a grid plan support system 40. The grid plan support system 40 includes a parameter tuning device 41 that inputs each data D5, D13, and D14 from the control candidate model database DB5, a correction target parameter data database DB13, and a correction confirmation signal database DB13 and performs parameter correction; and a correction result display unit 44 that displays the parameter correction result.

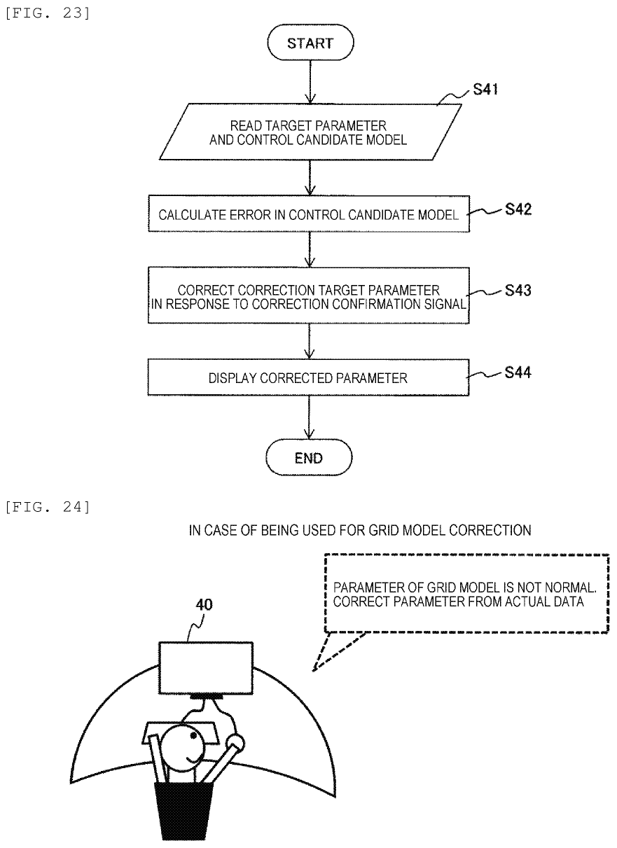

Here, the process flow will be described using FIG. 23. In a process step S41, the control candidate model data D5 and the target parameter data D13 are read. In a process step S42, an error in the control candidate model data D5 is calculated. In a process step S43, the correction target parameter is corrected according to the correction confirmation signal D14. In a process step S44, the corrected parameter is displayed.

The effect of Example 4 is illustrated in FIG. 24. For example, when there is an incomplete parameter of the system model and an error occurs in the control candidate model data D5, the parameters can be corrected. This parameter may be a load characteristic, a parameter in the power generator model, or a part of a model simulating the power grid. The grid plan is supported by using the grid plan support system 40.

### REFERENCE SIGNS LIST

1: decision-making support device
2: control candidate learning unit
3: control candidate extraction unit
4: control candidate evaluation unit
5: information presentation unit
10: measuring instrument
11: communication network
12: power grid
20: wide area monitoring protective control system
21: accidental event calculation device
22: control command generation unit
23: control target device
30: grid operator training system
32: operator evaluation unit
40: grid plan support system
41: parameter correction device
91: CPU
202: learning branch
DB1: accidental event analysis result data database
DB2: accumulated measurement data database
DB3: control data database
DB4: learning parameter data database
DB5: control candidate model data database
DB6: measurement data database
DB7: extraction parameter data database
DB8: grid model data database
DB9: control candidate data database
DB10: evaluation result data database
DB11: assumed event data database
DB12: virtual data database
DB13: correction target parameter data database
DB14: correction confirmation signal data database
H1: memory
H2: communication unit
H3: input unit
H4: bus
P: grid operator

1. A power grid decision-making support device comprising:
a control candidate learning unit that derives a plurality of control candidate models for stabilizing a power grid by learning;
a control candidate extraction unit that extracts control candidates using power grid measurement data and extraction parameters from the plurality of control candidate models derived by the control candidate learning unit;
a control candidate evaluation unit that evaluates the control candidates using the control candidates and a power grid model; and
an information presentation unit that presents information about the control candidates and the evaluation results.

2. The power grid decision-making support device according to claim 1, wherein
the control candidate learning unit includes an accidental event diffraction result data database that stores data on a power grid state after occurrence of an assumed failure in the power grid in time series, an accumulated measurement data database that stores data on an electrical quantity of the power grid in time series, a control data database that stores data on controls in the power grid in time series, and a learning parameter database that stores learning parameters, and
a plurality of characteristic amounts of an accidental event in the power grid are obtained for the data on the electrical quantity by using the learning parameters, a plurality of different controls are obtained for the control data, and a plurality of the control candidate models indicating a power grid state transitioned from an initial state of the power grid to a state after control through a state after an event are presented.

3. The power grid decision-making support device according to claim 2, wherein
the accidental event diffraction result data database includes, as accidental event analysis results, measurement data or virtual data in the power grid, and analysis results thereof.

4. The power grid decision-making support device according to claim 2, wherein
the control candidate model in the control candidate learning unit is obtained by integrating past accidental events in the power grid and an assumed event.

5. The power grid decision-making support device according to claim 1, wherein
the extraction parameter in the control candidate extraction unit includes one or more of parameters specifying characteristic amounts extracted from the measurement data and conditions extracted from the control candidate models.

6. The power grid decision-making support device according to claim 1, wherein
the control candidate evaluation unit evaluates control candidates by prediction calculation using the measurement data, the control candidates, and the grid model.

7. A wide area monitoring protective control system using the power grid decision-making support device according to claim 1, the wide area monitoring protective control system comprising:
a control command generation unit that creates a control command to be given to a power grid control target device by using the control candidates and the evaluation results from the decision-making support device as input; and
a control target device that is controlled by the control command.

8. The wide area monitoring protective control system according to claim 7, further comprising:
an accidental event calculation device that calculates an accidental event result using a grid model, an assumed event, and measurement data as input, wherein
the decision-making support device outputs the control candidates and the evaluation results using the accidental event result obtained by the accidental event calculation device as input.

9. A grid operator training system using the power grid decision-making support device according to claim 1, the grid operator training system comprising:
the decision-making support device that outputs the control candidates and the evaluation results by using virtual data as input;
an accidental event calculation device that calculates an accidental event using a control command given from a grid operator according to the output of the decision-making support device; and
an operator evaluation unit that evaluates the grid operator.

10. A grid plan support system using the power grid decision-making support device according to claim 1, the grid plan support system comprising:
the decision-making support device that outputs control candidate models;
a parameter correction device that performs parameter correction using the control candidate models, target parameters, and a correction confirmation signal as input; and
a display unit that displays a parameter correction result.

11. A power grid decision-making support method comprising:
deriving a plurality of control candidate models for stabilizing a power grid by learning;
extracting control candidates by using power grid measurement data and extraction parameters from the plurality of control candidate models;
evaluating the control candidates by using the control candidates and a power grid model; and
presenting information about the control candidates and the evaluation results.

12. The decision-making support method according to claim 11, further comprising:
storing data on a power grid state after the occurrence of an assumed event in the power grid in time series, storing electric quantity data in the power grid in time series, and storing control data in the power grid in time series, and
obtaining a plurality of characteristic amounts of an accidental event in the power grid for the electric quantity data by using learning parameters, obtaining a plurality of different types of control for the control data, and presenting a plurality of the control candidate models indicating a power grid state transitioned from an initial state of the power grid to a state after control through a state after an event.

13. A power grid decision-making support method comprising:
setting the state transitioning to a state after an event by an accidental event occurring in an initial state at the occurrence of the accidental event a power grid, and then to a state after control by controlling the power grid as a control candidate model;
determining an electrical quantity of the power grid for the event of the control candidate model from a plurality of characteristic amounts obtained according to learning parameters and assuming a plurality of types of control for the control of the control candidate model; and
setting a plurality of control candidate models determined by the plurality of characteristic amounts and the plurality of types of control and evaluating the plurality of control candidate models to extract control candidates.
